(19) United States
(12) Patent Application Publication
(10) Pub. No.: US 2004/0157047 A1
(43) Pub. Date: Aug. 12, 2004

(54) Continuous process for manufacturing electrostatically self-assembled coatings

(76) Inventors: Ali Mehrabi, Los Angeles, CA (US); Jay R. Akhave, Claremont, CA (US); Mark Licon, Diamond Bar, CA (US); Carol A. Koch, San Gabriel, CA (US)

Correspondence Address: Heidi A. Boehlefeld, Renner, Otto, Boisselle & Sklar, LLP, 1621 Euclid Avenue, Nineteenth Floor, Cleveland, OH, 44115-2191, US

(21) Appl. No.: 10/439,657

(22) Filed: May 16, 2003

Related U.S. Application Data
(60) Provisional application No. 60/445,702, filed on Feb. 6, 2003.

(51) Int. Cl. B32B 7/02

(52) U.S. Cl. 428/212

(57) ABSTRACT

A continuous process for manufacturing self-assembled multilayer coatings, and more particularly, to a continuous process for making multilayer coatings in a roll-to-roll process. A predetermined number of alternating nanoscopic layers of positively charged and negatively charges species are deposited on a moving substrate to form a multilayer composite coating on a substrate in roll form.

This application claims the benefit of provisional application 60/445,702 filed Feb. 6, 2003.

### BACKGROUND OF THE INVENTION

This invention relates to a continuous process for manufacturing self-assembled multilayer coatings, and more particularly, to a continuous process for making multilayer coatings in a roll-to-roll process.

Self-assembled monolayer coatings have been used as building units for constructing multilayer composites and as modifiers of surface properties. Self-assembled multilayer coatings are prepared by selective adsorption of compounds at solid/fluid interfaces to construct organized oriented compact monolayers of good quality and having a thickness of less than about 50 nanometers. The molecular self-assembly process takes place as a layer-by-layer process, that is based on the adsorption of either nonionic polymers, polyelectrolytes or nanoparticles from dilute aqueous solutions onto surfaces that carry a functional group or a charge opposite to that of the depositing polymer. Selective adsorption of these species is alternated to form a bilayer assembly and leads to the formation of multilayer assemblies. Colloidal species and rotaxane complexes may also be deposited in a self-assembly manner.

Such multilayer assemblies have found use in applications for full color flat displays, membrane separation, barrier coatings, corrosion control coatings, electrochromic coatings, electroluminescent devices, conducting and insulating circuits, optical and nonlinear optical devices, solar cells, high strength composites and multi-element chemical sensors.

U.S. Pat. No. 5,208,111 describes one or more multi-layer elements applied to supports. The elements consist of a modified support having an even surface, in which modification means the application of ions or ionizable compounds of the same charge over the entire area. One or more layers made of organic materials are applied to the support and each layer contains ions of the same charge. The ions of the first layer have the opposite charge of the modified support. In the case of several layers, each further layer has the opposite charge of the previous layer. The layer elements are applied to supports by applying the individual layers from solutions of organic materials. This results in one or more multi-layer elements covering an entire surface of the support.

U.S. Pat. No. 5,518,767 describes a molecular self-assembly process based on the alternating deposition of a p-type doped electrically conductive polycationic polymer and a conjugated or nonconjugated polyanion. In this process, monolayers of electrically conductive polymers are adsorbed onto a substrate from dilute solutions and subsequently built-up into multilayer thin films by alternating deposition with a soluble polyanion. The net positive charge of the conducting polymer can be systematically adjusted by simply varying its doping level. This patent discloses that with suitable choice of doping agent, doping level and solvent, it is possible to manipulate a wide variety of conducting polymers into exceptionally uniform multilayer thin films with layer thicknesses ranging from a single monolayer to multiple layers.

U.S. Pat. No. 5,536,573 describes a thin-film heterostructure bilayer is formed on a substrate by a molecular self-assembly process based on the alternating deposition of a p-type doped electrically conductive polycationic polymer and a conjugated or nonconjugated polyanion or water soluble, non-ionic polymer has been developed. In this process, monolayers of electrically conductive polymers are spontaneously adsorbed onto a substrate from dilute solutions and subsequently built-up into multilayer thin films by alternating deposition with a soluble polyanion or water soluble, non-ionic polymer. The net positive charge of the conducting polymer can be systematically adjusted by simply varying its doping level.

U.S. Pat. No. 6,022,590 discloses a two-step adsorption process for producing ordered organic/inorganic multilayer structures is provided. Multilayered films are formed on metallic and nonmetallic substrates by alternate adsorption of a cationic polyelectrolyte and anionic sheets of a silicate clay. The two-step adsorption process is not only fast but allows also for preparation of multilayer elements of thicknesses greater than about 2200 Angstroms on silicon, and greater than about 1500 Angstroms on gold, silver, and copper.

The foregoing multilayer structures are formed in batch, sequential dipping processes. None of the foregoing self-assembly processes involve a continuous process wherein the multilayer structure is deposited on a flexible substrate in a roll-to-roll manner.

### SUMMARY OF THE INVENTION

The process for producing a self-assembled multilayer coating of the present invention comprises the steps of (a) providing an extended length of flexible substrate having upper and lower surface by unwinding an input roll; (b) passing the flexible substrate through a first coating station having a first coating solution, wherein flexible substrate has a predetermined first residence time in the first coating solution; (c) passing the flexible substrate through a first rinsing station wherein the flexible substrate is contacted with a suitable solvent; (d) optionally, passing the flexible substrate through a first drying station, wherein passing the flexible substrate through the first coating, rinsing and drying stations results in the forming of a first monolayer on at least one surface of the flexible substrate; (e) passing the flexible substrate through a second coating station having a second coating solution, wherein flexible substrate has a predetermined second residence time in the second coating solution; (f) passing the flexible substrate through a second rinsing station wherein the flexible substrate is contacted with a suitable solvent; (g) optionally, passing the flexible substrate through a second drying station, wherein passing the flexible substrate through the second coating, rinsing and drying stations results in the forming of a second monolayer on at least one surface of the flexible substrate; and (h) repeating the coating, rinsing, drying steps so that a predetermined plurality of alternating monolayers are built up uniformly upon the at least one surface of the flexible substrate.

In another aspect of the present invention, a process for producing a self-assembled multilayer coating comprises the steps of (a) providing an extended length of flexible substrate having upper and lower surface by unwinding an input roll; (b) passing the flexible substrate through a first coating station having a first coating solution, wherein the flexible substrate has a predetermined first immersion time in the first coating solution; (c) passing the flexible substrate through a first drying station, wherein passing the flexible substrate through the first coating and drying stations results in the forming of a first monolayer on at least one surface of the flexible substrate; (d) passing the flexible substrate through a second coating station having a second coating solution, wherein flexible substrate has a predetermined second immersion time in the second coating solution; (e) passing the flexible substrate through a second drying station, wherein passing the flexible substrate through the second coating and drying stations results in the forming of a second monolayer on at least one surface of the flexible substrate; and (f) repeating the coating and drying steps so that a predetermined plurality of alternating monolayers, each monolayer having a thickness of less than 50 nanometers, is built up uniformly upon the at least one surface of the flexible substrate.

Each monolayer may comprise a different material, so long as the monolayer has the opposite charge as that of the preceding monolayer and the subsequent monolayer.

The process of the invention is a roll-to-roll process wherein a continuous web of substrate material is unwound, coated with the multilayer composite and then rewound into roll form. The coating of each monolayer may be carried out by dip coating, spray coating, roll coating, or any other coating process that permits the coating solution to contact the substrate. Each coated monolayer is ultra thin, having a thickness in the nanoscopic range.

The present invention is further directed to a self-assembled multilayer composite on a flexible substrate comprising at least one first monolayer having a thickness of less than 50 nanometers, and at least one second monolayer having a thickness of less than 50 nanometers, wherein the multilayer composite on the flexible substrate is in roll form. In another embodiment, one or both of the monolayers have a thickness of less than about 40 nanometers, or less than about 30 nanometers.

### BRIEF DESCRIPTION OF THE DRAWINGS

FIG. 1 is an illustration of a machine used to produce the multilayer coatings of the present invention in a continuous manner.

FIG. 2 is an illustration of an alternative embodiment of the dip coating station of the apparatus used to produce the multilayer coating.

FIGS. 3A and 3B are illustrations of an alternative embodiment of the coating station of the machine used to produce the multilayer coating.

FIG. 4 is an illustration of the roll-to-roll process of the present invention.

### DETAILED DESCRIPTION OF THE INVENTION

The present invention is directed to a continuous process for depositing a plurality of ultrathin layers, one on top of another, each layer being deposited in a self-assembly manner. Electrostatically self-assembled (ESA) coatings include those described in U.S. Pat. Nos. 5,208,111; 5,518,767; 5,536,773; 6,022,590; 6,100,329; and 6,114,099, the entire disclosures of which are incorporated herein by reference. The deposition mechanism is controlled by the kinetics of the self-assembly process. In general, the multilayer composite coating is made up of a plurality of alternating positively and negatively charged species that are locked in place by the electrostatic forces between the species, forming a permanent multilayer structure. In addition to electrostatic forces, other forces may be used for the multilayer assembly process. Such other forces include, but are not limited to hydrogen bonding, covalent bonding, Van der Waals' forces, stereocomplex formation, specific recognition and donor/acceptor interactions. Each layer is referred to as a monolayer and together, a pair of the positively charged monolayer and negatively charged monolayer are referred to as a bilayer.

In one embodiment, the multilayer coating is made up of alternating monolayers of a cationic polyelectrolyte and a negatively charged inorganic material. In another embodiment, the coating is made up of alternating monolayers of a hydrogen bonding polymer and a negatively charged inorganic material. The number of alternating layers of the coating is dependent on the desired properties of the coating, the composition of the underlying substrate and the application to which the coating is applied.

The monolayers are deposited from dilute solutions of the charged species. The process of the present invention involves a continuously moving substrate web that is passed through sequential dipping stations and recirculated a number of times until a predetermined plurality of alternating monolayers are built up on the continuously moving web. A washing step between alternating coating steps is generally used to avoid contamination of the next adsorption solution by liquid adhering to the substrate from the previous adsorption step and to remove unadsorbed materials. Any rinsing means may be used to remove the unadsorbed material from the surface of the coating. Upon completion of the formation of the multilayer composite, the web is then removed from the coating apparatus and wound into a roll.

In one aspect of the present invention, the process for producing a self-assembled multilayer coating comprises the steps of (a) providing an extended length of flexible substrate having upper and lower surface by unwinding an input roll; (b) passing the flexible substrate through a first dipping station having a first dipping solution, wherein the flexible substrate has a predetermined first residence time in the first dipping solution; (c) passing the flexible substrate through a first rinsing station wherein the flexible substrate is contacted with a suitable solvent; (d) passing the flexible substrate through a first drying station, wherein passing the flexible substrate through the first dipping, rinsing and drying stations results in the formation of a first monolayer on at least one surface of the flexible substrate; (e) passing the flexible substrate through a second dipping station having a second dipping solution, wherein flexible substrate has a predetermined second residence time in the second dipping solution; (f) passing the flexible substrate through a second rinsing station wherein the flexible substrate is contacted with a suitable solvent; (g) passing the flexible substrate through a second drying station, wherein passing the flexible substrate through the second dipping, rinsing and drying stations results in the formation of a second monolayer on at least one surface of the flexible substrate; and (h) repeating the dipping, rinsing, drying steps so that a predetermined plurality of alternating monolayers are built up uniformly upon the at least one surface of the flexible substrate.

In the continuous dipping process configuration, the time of contact of the substrate to the coating solution (“residence time”) consists of actual immersion time, in addition to the time from removal from the dip tank prior to the rinsing step where the excess (unadsorbed) material is removed.

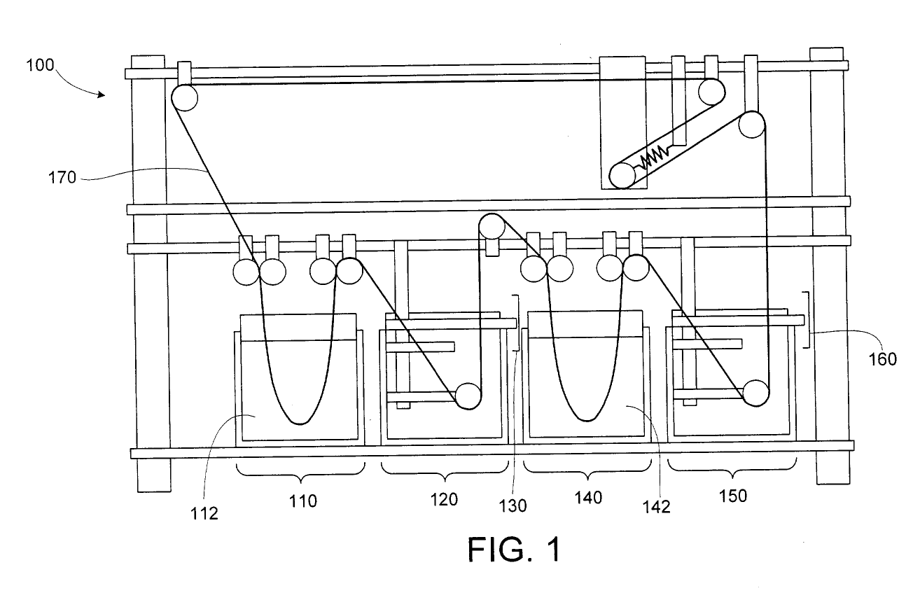

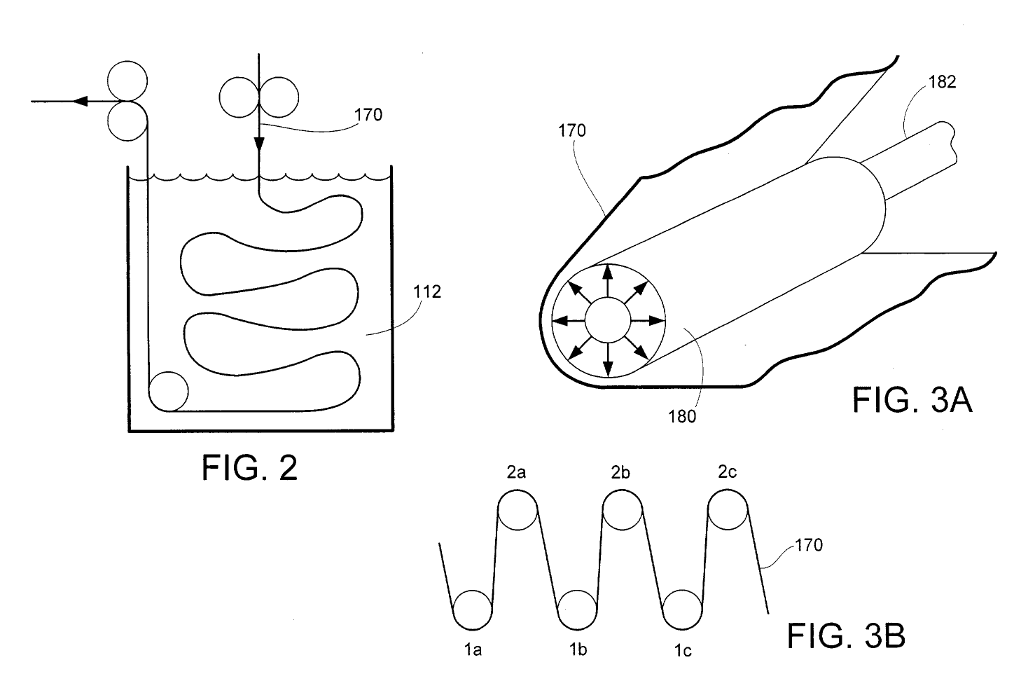

Referring now to FIG. 1, an apparatus for carrying out the process of the present invention is shown. Continuous dip coater 100 has first dip coating station 110, first rinsing station 120, first drying station 130, second dip coating station 140, second rinsing station 150, and second drying station 160. Continuous substrate web 170 is initially unwound and is passed through first dip coating station 110, where it is immersed in dip tank 112 filled with a first dipping solution for a predetermined immersion time. In one embodiment illustrated in FIG. 2, a sidewinder is used within the dip tank to move the web 170 through the dipping solution. The immersion time is determined by the speed at which substrate web 170 is traveling, the depth of dip tank 112, the length of substrate web within dip tank 112 (referred to as the web holdup), the concentration of the first dipping solution and the molar mass of the charged species to be deposited, as well as additional process factors, including agitation of the dipping bath. In one embodiment, the immersion time is less than one minute. Following first dip coating station 110, substrate web 170 passes through first rinsing station 120. In one embodiment, first rinsing station 120 has a pair of water knives on either side of the substrate web. The rinsing solvent may be water, an alcohol, an aromatic, or any combination thereof. The rinsing solvent may comprise a salt containing solution to remove extra-adsorbed layers. Following first rinsing station 120, substrate web 170 passes through first drying station 150. In one embodiment, first drying station 150 comprises a pair of air knives on either side of web 170. Drying of the web may be carried out with ambient air, inert gas, heated air, heated inert gas, a vacuum, or any combination thereof. Upon passing through first dip coating station 110, first rinsing station 120 and first drying station 120, flexible substrate web 170 has deposited on at least one surface a first monolayer having a thickness of less than 50 nanometers. In one embodiment, the first monolayer comprises an ultra thin layer of a positively charged organic material.

Substrate web 170 with first monolayer deposited thereon then passes through second dip coating station 140, where it is immersed in dip tank 142 filled with a second dipping solution for a predetermined immersion time. The immersion time is determined by the speed at which substrate web 170 is traveling, the depth of dip tank 142, the length of substrate web within dip tank 142, the concentration of the second dipping solution, the molar mass of the charges species to be deposited, as well as additional process factors, including the agitation of the dipping bath. In one embodiment, the immersion time is less than one minute. Following second dip coating station 140, substrate web 170 passes through second rinsing station 150. In one embodiment, second rinsing station 150 has a pair of water knives on either side of the substrate web. The rinsing solvent may be water, an alcohol, an aromatic, or any combination thereof. Following second rinsing station 150, substrate web 170 passes through second drying station 160. In one embodiment, second drying station 160 comprises a pair of air knives on either side of web 170. Drying of the web may be carried out with ambient air, inert gas, heated air, heated inert gas, a vacuum, or any combination thereof. Upon passing through second dip coating station 140, second rinsing station 150 and second drying station 160, flexible substrate web 170 with the first monolayer thereon, has a second monolayer having a thickness of less than 50 nanometers, deposited thereon. In one embodiment, the second monolayer comprises an ultra thin layer of a negatively charged inorganic material.

Substrate web 170 is recirculated through continuous dip coater 110 to deposit a predetermined number of alternating first and second monolayers. When the desired multilayer coating has been deposited onto the flexible substrate web 170, the web 170 removed from the continuous coating apparatus and wound in a roll.

The temperature at which the coating process is carried out is generally within the range of about 5° C. to about 90° C. In one embodiment, the process is carried out within the temperature range of about 20° C. to about 50° C.

In one embodiment of the process of the present invention, the speed of the substrate is at least 3 ft/min. In another embodiment, the speed of the substrate is at least about 5, or about 20 ft/min, or about 30 ft/min. In yet another embodiment, the speed of the substrate is at least about 100 ft/min.

In an alternative embodiment, the dip tanks of the first and second dip coating stations are replaced with coating rolls. Referring to FIG. 3A, substrate web 170 is contacted with coating roll 180 to which the coating solution is fed via supply feed 182. Coating roll 180 is a porous roll and the flow of the coating solution through the pores of the coating roll 180 is driven by pressure. The alternating monolayers are coated onto the moving substrate web 170 by sequential coating rolls as illustrated in FIG. 3B. The first monolayer of the bilayer is coated onto the web 170 by rolls 1a-1c, etc., and the second monolayer of the bilayer is coated onto the web 170 by rolls 2a-2c, etc. The sequential coating rolls are made up at least one coating roll for the first monolayer and at least one coating roll for the second monolayer. The moving web 170 can be recirculated through the sequential coating rolls as many times as needed to apply the desired number of bilayers. Rinsing and drying stations can be placed between each of the coating rolls. Uniform rinsing between coating steps results in a superior monolayer.

In another alternative embodiment, the dip tanks of the first and second dip coating stations are replaced with spray coaters. In yet another embodiment, the dip tanks of the first and second dip coating stations are replaced with conventional nip roll coaters. The process of the present invention may include any other coating method in which the substrate is in contact with the coating solution.

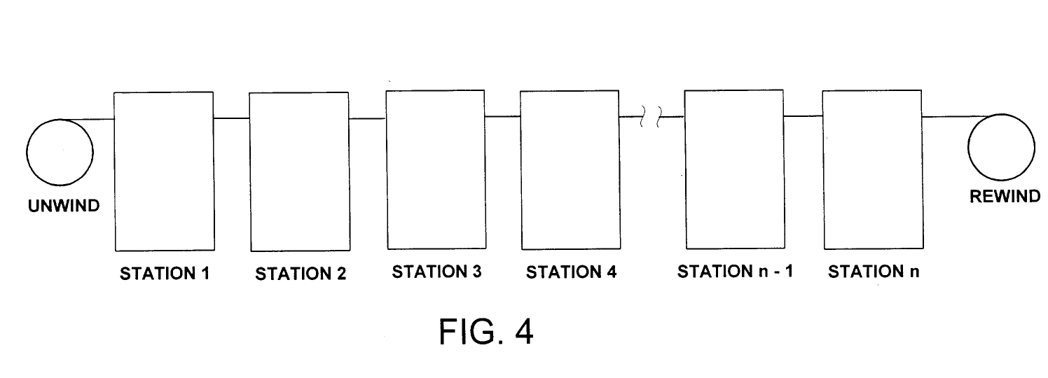

The process of the present invention is a roll-to-roll process as illustrated in FIG. 4. The substrate is unwound from an initial feed roll, passed through the various coating, washing and optional drying stations and then wound on a final roll. Each coating station may coat a different adsorbed material onto the moving substrate.

In one embodiment of the invention, the process for producing a self-assembled multilayer coating does not include a rinsing step between coating steps. The process comprises the steps of (a) providing an extended length of flexible substrate having upper and lower surface by unwinding an input roll; (b) passing the flexible substrate through a first coating station having a first coating solution, wherein the flexible substrate has a predetermined first immersion time in the first coating solution; (c) passing the flexible substrate through a first drying station, wherein passing the flexible substrate through the first coating and drying stations results in the forming of a first monolayer on at least one surface of the flexible substrate; (d) passing the flexible substrate through a second coating station having a second coating solution, wherein flexible substrate has a predetermined second immersion time in the second coating solution; (e) passing the flexible substrate through a second drying station, wherein passing the flexible substrate through the second coating and drying stations results in the forming of a second monolayer on at least one surface of the flexible substrate; and (f) repeating the coating and drying steps so that a predetermined plurality of alternating monolayers, each monolayer having a thickness of less than 50 nanometers, is built up uniformly upon the at least one surface of the flexible substrate.

The flexible substrate onto which the multilayer coating is deposited may be any substrate that the charged species can be adsorbed directly, or indirectly with the aid of an adhesion promoter or tie layer. The substrate may be a polymeric material, paper or a metallic material. The substrate may also be a polymeric material coated with an inorganic material. In one embodiment, the substrate is a fibrous material. In one embodiment, the substrate is optically transparent. Examples of useful polymeric substrates include those selected from polyolefins (linear or branched), halogenated polyolefins, polyamides, polystyrenes, nylon, polyesters, polyester copolymers, polyurethanes, polysulfones, styrene-maleic anhydride copolymers, styrene-acrylonitrile copolymers, ionomers based on sodium or zinc salts of ethylene methacrylic acid, polymethyl methacrylates, cellulosics, acrylic polymers and copolymers, polycarbonates, polyacrylonitriles, and ethylene-vinyl acetate copolymers. Included in this group are the acrylates such as ethylene methacrylic acid, ethylene methyl acrylate, ethylene acrylic acid and ethylene ethyl acrylate. Also included in this group are polymers and copolymers of olefin monomers having, for example, 2 to about 12 carbon atoms, and in one embodiment, 2 to about 8 carbon atoms. These include the polymer of α-olefins having from 2 to about 4 carbon atoms per molecule. These include polyethylene, polypropylene, poly-1-butene, etc. Films prepared from blends of copolymers or blends of copolymers with homopolymers are also useful. The substrate can be a single-layered film or it can be a multi-layered construction.

The thickness of the substrate may be in the range of about 0.3 to about 20 mils, and in one embodiment, about 0.3 to about 10 mils, and in one embodiment about 0.5 to about 5 mils, and in one embodiment about 1 to about 4 mils.

In one embodiment, at least one surface of the substrate is embossed, microembossed, nanoembossed or patterned to increase the surface area of the substrate surface, or to add other functionality to the final product.

The substrate may be an untreated film that is amenable to adsorption. Alternatively, this film may be treated by first exposing the film to an electron discharge treatment at the surface, e.g., corona treatment. Other surface treatments to enhance the adsorption of the charged species are well known. For example, the substrate may be plasma treated prior to application of the self-assembled coating. Additionally, polymeric films that have been pretreated to promote adhesion are commercially available. Examples of such pretreated films include the PET films available from DuPont Teijin Films under the designations ST504 (one side treated) and ST505 (both sides treated).

In one embodiment, the first monolayer deposited onto the substrate comprises a cationic polyelectrolyte. Useful cationic polyelectrolytes include polydiallyidimethyl ammonium chloride (PDDA), polyallylamine hydrochloride, and copolymers containing quaternary ammonium acrylic monomers. Examples of quaternary ammonium acrylic monomers include methacryloxyethyltrimethyl ammonium chloride, acryloxyethyl dimethylbenzyl ammonium chloride, methacryloxyethyl dimethylbenzyl ammonium chloride and acryloxyethyltrimethyl ammonium chloride. Polymers capable of hydrogen bonding, or hydrogen donors include polyethyleneimine, polyvinylimidazole, polylysine, poly-N-methyl-N-vinylacetamide, polyvinyl-pyrrolidone, polyvinyl alcohol, polyacrylamide and copolymers of aminoacrylates. The polymers can also become cationic at low pH due to protonation. Copolymers of acrylamide and acryloxytrimethylammonium chloride are particularly useful.

Substituted acrylamides and methacrylamides may be included into the copolymer in relatively small amounts. In large amounts, substituted acrylamides and methacrylamides adversely affect the solubility of the polycation.

In one embodiment, the cationic copolymer comprises a copolymer of acrylamide monomer and acryloxyethyltrimethyl ammonium chloride. In another embodiment, the cationic copolymer comprises a cationic acrylamide commercially available from Cytec under the trade name Superfloc C-491. In yet another embodiment, the cationic copolymer comprises a cation-modified polyvinyl alcohol commercially available from Kuraray under the designation CM-318.

Cationic polyelectrolytes with a relatively low charge density have been found to provide better barrier properties than such polyelectrolytes with a higher charge density. As used herein, the charge density is the mole percentage of cationic monomer in the cationic polymer. The charge density of the cationic polymer is preferably less than 50%.

In one embodiment of the present invention, the second monolayer deposited onto the substrate comprises a negatively charged inorganic material. Such inorganic material includes negatively charged platelets having a thickness of less than about 10 nanometers. Useful inorganic material includes platelet clays that are easily exfoliated in aqueous or polar solvent environments. The clays may be naturally occurring or synthetic. Platelet clays are layered crystalline aluminosilicates. Each layer is approximately 1 nanometer thick and is made up of an octahedral sheet of alumina fused to 2 tetrahedral sheets of silica. These layers are essentially polygonal two-dimensional structures, having a thickness of 1 nanometer and an average diameter ranging from 30 to 2000 nanometers. Isomorphic substitutions in the sheets lead to a net negative charge, necessitating the presence of cationic counter ions (Na+, Li+, Ca++, Mg++, etc.) in the inter-sheet region. The sheets are stacked in a face-to-face configuration with inter-layer cations mediating the spacing. The high affinity for hydration of these ions allows for the solvation of the sheet in an aqueous environment. At sufficiently low concentrations of platelets, for example less than 1% by weight, the platelets are individually suspended or dispersed in solution. This is referred to as “exfoliation”.

Particularly useful are clays belonging to the smectite family of clay, including montmorillonite, saponite, beidellite, nontronite, hectorite, laponite fluorohectorite and mixtures of these. A preferred clay is montmorillonite. This clay is usually present in a sodium ion exchange form. Montmorillonite clay is commercially available from Southern Clay Products, Inc. under the trade name Cloisite. In one embodiment, the clay comprises sodium montmorillonite.

Other types of nanoparticles that may be used include inorganic nanoparticles, metallic nanoparticles, organic-inorganic hybrid nanoparticles, organic nanoparticles, layered double hydroxides, or perovskites. Such nanoparticles may be used to impart certain functionality to the coating. These nanoparticles generally carry a charge or alternatively, they can be charged by stabilizing with a variety of different polyelectrolytes or surfactants.

Other useful inorganic materials in platelet form include layered titanates, including those within the chemical formula Ti_{1-δ}O₂^{4-δ}; layered perovskites, including HCa₂Nb₃O₁₀, HSrNb₃O₁₀, HLaNb₂O₇ and HCaLaNb₂TiO₁₀; and mica.

In one embodiment of the present invention, the first monolayer comprises an organic material that is a monomeric substance having two ionic or ionizable functional groups of the same charge or polymers having a multiplicity of ionic or ionizable functional groups of the same charge and the second monolayer comprises an organic material of opposite charge.

In another embodiment of the present invention, the first monolayer comprises a p-doped conjugated polymer and the second monolayer comprises a polymer selected from the group consisting of polyanions and water soluble, non-ionic polymers that are bound to the p-doped conjugated polymer of the first monolayer.

In yet another embodiment, the first monolayer comprises a polymer having a linear segment and the second monolayer comprises a second polymer having at least one macrocycle that is capable of being physically threaded onto the linear segment of the first polymer to form a rotaxane complex. Such complexes are disclosed in U.S. Pat. No. 6,100,329, which is incorporated by reference herein in its entirety.

The flexible substrate with the multilayer composite structure thereon that is in roll form, may be further processed for various applications. For example, the rolled product may be used to form laminate structures by the application of heat and/or pressure. Alternatively, an adhesive layer may be applied to the multilayer coating for application to another substrate or layered structure.

In one aspect of the invention, one side of the substrate is coated, while the other side remains uncoated. This selective coating may be carried out by any method known in the art, including but not limited to, providing one surface of the substrate with a non-adsorbing surface, temporarily laminating two films together for the coating process and then subsequently separating the two films, masking one side of the substrate, etc. In a further aspect of the invention, one or both sides of the substrate may be patterned coated by masking a portion of the substrate, selectively applying a non-adsorbing material to the substrate, or selectively applying an absorption enhancing material to the substrate, etc.

In another aspect of the invention, the rolled product may be exposed to electron beam or ultraviolet radiation to cure one or more of the polymeric monolayers. Radiation exposure may be used to alter the hydrophobicity of one or more of the polymeric monolayers.

In a further aspect of the invention, a self-supporting film is prepared by depositing a multilayer film onto a carrier and then removing the carrier or laminating the deposited multilayer film to another film/substrate on a continuous, e.g., roll-to-roll basis.

In one aspect of the invention, ferromagnetic particles are incorporated within one or more of the monolayers. Upon applying an electromagnetic field to the multilayer composite, heat is generated that can be useful for crosslinking or polymerizing the polymeric materials within the monolayer(s). Alternatively or in addition, the heat generated can be used to soften a thermoplastic polymeric material within the composite for subsequent embossing or other processing.

The coating process itself may be enhances using artificially induces driving forces for adsorption of the particular species being coated. For example, an external electric field, ultrasonification, or an external magnetic field may be used to enhance and accelerate the deposition process.

The present invention will be further understood by reference to the following non-limiting examples. All concentrations and percentages are based upon weight, unless otherwise specified.

### EXAMPLES

### Preparation of Cationic Organic Solution

Acrylamide monomer (51.64 g) and acryloxyethyltrimethylammonium chloride (1.836 g) were dissolved in deionized water (301.469 g) and transferred to a one-liter glass-walled reactor and purged with nitrogen while stirring. The reactor was heated to 30° C. and the following was added: ammonium persulfate (0.0679 g) in deionized water (5.43 g) and sodium metabisulfite (0.0591 g) in deionized water (5.00 g). An exotherm occurred in about 5 min., increasing the temperature to 52° C. The reaction was maintained at 50° C. for 2 hours, at which time an additional amount of catalyst was added: ammonium persulfate (0.0666 g) in deionized water (6.83 g) and sodium metabisulfite (0.0420 g) in deionized water (6.39 g). The temperature was kept at 50° C. for another hour and then the reactor was cooled. Analysis by liquid chromatography showed very low residual monomers, <50 ppm acrylamide and <100 ppm acryloxyethyltrimethylammonium chloride. The polymer was precipitated in acetone and dried, then redissolved in ultrapure water, <18 megaohms, at a concentration of 1.1 to 1.4 weight %.

### Preparation of Inorganic Solution

Sodium montmortillonite (0.3961 g), available as Cloisite Na+from Southern Clay Products, was dissolved in ultrapure water (765.98 g) and stirred resulting in a slightly hazy solution. The solution was allowed to stand for at least 24 hours before use.

### Example 1

A nanocoating barrier film is prepared by continuously dip coating alternating layers of a cationic organic material and an inorganic material onto a PET substrate (ST505). A cationic organic solution of poly-diallyidimethyl ammonium chloride (PDDA) in deionized water (0.25%) is prepared. An inorganic solution of sodium-montmortillonite in deionized water (0.05%) is prepared. A semi-continuous loop coater is used to cycle a 5 mil PET substrate web through the alternating coating solutions. The PET substrate is 31 feet in length and 12 inches wide. The ends of the web are spliced together using a water-resistant silicone tape to form a loop. The speed of the substrate through the coater is 3 ft/min. With the exception of the deposition of the first PDDA layer, the substrate is washed and dried after the deposition of each individual layer. The substrate is coated with 40 bilayers, unloaded from the coater and then dried for 3 days.

The oxygen transmission rate (OTR) of the coated substrate, taken from samples cut from different locations along the web, is shown below in Table 1. The OTR of a PET substrate coated using a batch robotic dipper with the same coating solution, residence time and number of bilayers is also shown in Table 1 for comparison.

Oxygen transmission rate, OTR, is measured using a MOCON Ox-Tran 2/20 (ML System) at 23° C. and dry conditions (<2% relative humidity) according to ASTM D3985. The lower detection limit of the instrument is 0.005 cc/m² day.

TABLE 1

| Sample | OTR (cc/m²day) |
|---|---|
| 1a | 8.94 |
| 1b | 8.54 |
| 1c | 8.73 |
| 1d | 8.52 |
| Comparative (Batch) | 12.60 |

### Example 2

A nanocoating barrier film is prepared substantially in accordance with the procedure described in Example 1, with the following exceptions. The cationic organic solution used is polyacrylamide in water (1.5%). The substrate is a 7 mil PET substrate (ST505). The speed of the substrate through the coater is 2.5 f/min. The oxygen transmission rate (OTR) of the coated substrate, taken from samples cut from different locations along the web, is shown below in Table 2.

TABLE 2

| Sample | OTR (cc/m²day) |
|---|---|
| 2a | 0.07 |
| 2b | 0.02 |
| 2c | 0.06 |
| 2d | 0.02 |

### Example 3

A nanocoating barrier film is prepared substantially in accordance with the procedure described in Example 1, with the exception that the 7 mil PET substrate (ST505) was corona treated prior to coating the barrier film. The oxygen transmission rate (OTR) of the coated substrate, taken from samples cut from different locations along the web, is shown below in Table 3.

TABLE 3

| Sample | OTR (cc/m²day) |
|---|---|
| 3a | 0.005 |
| 3b | <0.005 |
| 3c | 0.03 |
| 3d | <0.005 |
| 3e | <0.005 |
| 3f | <0.005 |

### Example 4

A nanocoating barrier film on a PET substrate (ST505) is prepared substantially in accordance with the procedure described in Example 1, with the exception that the substrate speed is 10 ft/min. The oxygen transmission rate (OTR) of the coated substrate, taken from samples cut from different locations along the web, is shown below in Table 43.

TABLE 4

| Sample | OTR (cc/m²day) |
|---|---|
| 4a | <0.005 |
| 4b | <0.005 |
| 4c | <0.005 |
| 4d | <0.005 |

Although the invention has been shown and described with respect to a certain embodiment or embodiments, it is obvious that equivalent alterations and modifications will occur to others skilled in the art upon the reading and understanding of this specification. In particular regard to the various functions performed by the above described elements (components, assemblies, compositions, etc.), the terms used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A process for producing a self-assembled multilayer coating comprising:
providing an extended length of flexible substrate having upper and lower surface by unwinding an input roll;
passing the flexible substrate through a first coating station having a first coating solution, wherein the flexible substrate has a predetermined first immersion time in the first coating solution;
passing the flexible substrate through a first rinsing station wherein the flexible substrate is contacted with a suitable solvent;
passing the flexible substrate through a first drying station, wherein passing the flexible substrate through the first coating, rinsing and drying stations results in the forming of a first monolayer on at least one surface of the flexible substrate;
passing the flexible substrate through a second coating station having a second coating solution, wherein flexible substrate has a predetermined second immersion time in the second coating solution;
passing the flexible substrate through a second rinsing station wherein the flexible substrate is contacted with a suitable solvent;
passing the flexible substrate through a second drying station, wherein passing the flexible substrate through the second coating, rinsing and drying stations results in the forming of a second monolayer on at least one surface of the flexible substrate; and
repeating the coating, rinsing, drying steps so that a predetermined plurality of alternating monolayers is built up uniformly upon the at least one surface of the flexible substrate.

2. The process of claim 1 wherein the first coating station comprises a dip tank.

3. The process of claim 1 wherein the first coating station comprises a sprayer.

4. The process of claim 1 wherein the first coating station comprises a roll coater.

5. The process of claim 1 wherein the second coating station comprises a dip tank.

6. The process of claim 1 wherein the second coating station comprises a sprayer.

7. The process of claim 1 wherein the second coating station comprises a roll coater.

8. The process of claim 1 wherein the flexible substrate is surface treated to make the substrate more receptive to adsorption of the first monolayer.

9. The process of claim 1 wherein the rinsing solvent is selected from the group consisting of water, an alcohol, an aromatic or any combination thereof.

10. The process of claim 1 wherein the rinsing solvent is water.

11. The process of claim 1 wherein the drying is carried out in ambient air, inert gas, heated air, heated inert gas, a vacuum, or any combination thereof.

12. The process of claim 1 wherein the first immersion time is less than one minute.

13. The process of claim 1 wherein the second immersion time is less than one minute.

14. The process of claim 1 wherein the process is carried out at a temperature of about 5° C. to about 90° C.

15. The process of claim 1 further comprising winding the flexible substrate with the predetermined plurality of alternating monolayers on at least one surface thereof into a roll.

16. The process of claim 1 wherein the first dipping solution comprises an aqueous solution of cationic polyelectrolyte.

17. The process of claim 16 wherein the cationic polyelectrolyte comprises a copolymer of polyacrylamide and acryloxyethyltrimethyl ammonium chloride.

18. The process of claim 1 wherein the first dipping solution comprises an aqueous solution of a hydrogen bonding polymer.

19. The process of claim 16 wherein the cationic polyelectrolyte has a charge density of less than 50%.

20. The process of claim 1 wherein the second dipping solution comprises an aqueous solution of negatively charged nanoscopic platelets of inorganic silicate.

21. The process of claim 20 wherein the inorganic material comprises silicate clay, layered titanates or layered perovskites.

22. The process of claim 21 wherein the silicate clay is selected from the group consisting of montmorillonite, saponite, beidellite, nontronite, and hectorite clays.

23. The process of claim 22 wherein the silicate clay comprises sodium exchanged montmorillonite.

24. The process of claim 1 wherein the flexible substrate comprises a polymeric film.

25. The process of claim 1 wherein the substrate comprises a transparent polymeric film.

26. The process of claim 1 wherein the average thickness of each first monolayer is less than about 30 nanometers.

27. The process of claim 1 wherein the average thickness of each second monolayer is less than about 5 nanometers.

28. A process for producing a self-assembled multilayer coating comprising:
providing an extended length of flexible substrate having upper and lower surface by unwinding an input roll;
passing the flexible substrate through a first coating station having a first coating solution, wherein the flexible substrate has a predetermined first immersion time in the first coating solution;
passing the flexible substrate through a first drying station, wherein passing the flexible substrate through the first coating and drying stations results in the forming of a first monolayer on at least one surface of the flexible substrate;
passing the flexible substrate through a second coating station having a second coating solution, wherein flexible substrate has a predetermined second immersion time in the second coating solution;
passing the flexible substrate through a second drying station, wherein passing the flexible substrate through the second coating and drying stations results in the forming of a second monolayer on at least one surface of the flexible substrate; and
repeating the coating and drying steps so that a predetermined plurality of alternating monolayers, each monolayer having a thickness of less than 50 nanometers, is built up uniformly upon the at least one surface of the flexible substrate.

29. A self-assembled multilayer composite on a flexible substrate comprising at least one first monolayer having a thickness of less than 50 nanometers, and at least one second monolayer having a thickness of less than 50 nanometers, wherein the multilayer composite on the flexible substrate is in roll form.
